(19) United States
(12) Patent Application Publication
(10) Pub. No.: US 2025/0160541 A1
(43) Pub. Date: May 22, 2025

(54) DISPLAY DOOR FOR TEMPERATURE-CONTROLLED ENCLOSURE

(71) Applicant: Anthony, Inc., Sylmar, CA (US)

(72) Inventor: Ibrahim Chandabhai, Reseda, CA (US)

(21) Appl. No.: 18/513,050

(22) Filed: Nov. 17, 2023

(51) Int. Cl. A47F 3/04; E05D 7/081

(52) U.S. Cl. CPC A47F 3/043; E05D 7/081; E05Y 2800/12; E05Y 2900/202; E05Y 2900/31

(57) ABSTRACT

A temperature-controller enclosure for displaying cold items includes a body, a frame assembly, and one or more doors coupled to the frame assembly. The body including a front opening and defining an interior space of the enclosure. The frame assembly is coupled in the front opening of the body. At least one of the doors includes an insulated panel assembly and an upper and lower hinge. The insulated panel assembly includes two or more panes each including an outer edge. The upper hinge and the lower hinge each include a hinge axis and are coupled to the insulated panel assembly such that the hinge axes are inside the outer edge of at least one of the two or more panes.

### TECHNICAL FIELD

The present disclosure relates to temperature-controlled storage devices, doors, and associated frames used in such devices.

### BACKGROUND

Refrigerated enclosures are used in commercial, institutional, and residential applications for storing and/or displaying refrigerated or frozen objects. Refrigerated enclosures may be maintained at temperatures above freezing (e.g., a refrigerator) or at temperatures below freezing (e.g., a freezer). Refrigerated enclosures have one or more doors or windows for accessing and viewing refrigerated or frozen objects within a temperature-controlled space. Refrigerated enclosures typically include a frame that supports the doors or windows.

Condensation on sealing surfaces of doors of refrigerated enclosures and their associated frames can impair sealing and decrease energy efficiency. Formation of condensation (or frost formation) on a door also affects visibility to product placed inside enclosure and may cause customer dissatisfaction. Electric heater wires are sometimes employed in the thermal frames of commercial refrigerated enclosures to inhibit condensation. However, electrical heaters can use a significant amount of electrical power. Excess reliance on such heater wires may make ever more stringent government regulations on energy efficiency more difficult to meet.

### SUMMARY

The present disclosure relates to temperature-controlled storage devices, and doors and associated frames used in such devices. Some implementations include a display door having hinges above and below an insulated panel assembly of the door.

In a general aspect of the disclosure, a temperature-controller enclosure for displaying cold items includes a body, a frame assembly, and one or more doors coupled to the frame assembly. The body includes a front opening and defining an interior space of the enclosure. The frame assembly is coupled in the front opening of the body. At least one of the doors includes an insulated panel assembly and an upper and lower hinge. The insulated panel assembly includes two or more panes each including an outer edge. The upper hinge and the lower hinge each include a hinge axis and are coupled to the insulated panel assembly such that the hinge axes are inside the outer edge of at least one of the two or more panes.

In some implementations, the door further includes an upper rail and a lower rail each coupled to the insulated panel assembly, the lower hinge is coupled to the lower rail, and the upper hinge is coupled to the upper rail.

In some implementations, at least a portion of the upper hinge, the lower hinge, or both are behind at least one of the panes.

In some implementations, at least a portion the upper hinge, the lower hinge, or both are below at least one of the panes.

In some implementations, the door further includes an adhesive between at least one of the panes and the upper rail or the lower rail.

In some implementations, the door further includes a guard along the outer edge of at least one of the panes.

In some implementations, the door further includes an insulating device coupled to the frame assembly and configured to contact the door assembly such that heat transfer is inhibited between ambient air around the temperature-controlled storage enclosure and the interior space of the temperature-controlled enclosure.

In some implementations, the insulating device is configured to form a seal between the frame assembly and the door when the door is closed.

In some implementations, the insulating device includes two or more blades configured to resiliently contact the door when the door assembly is closed on the temperature-controlled enclosure.

In some implementations, the one or more doors include two or more doors, at least one of the doors including an inter-door insulating device extending between two of the doors and configured to inhibit heat transfer between ambient air around the temperature-controlled storage enclosure and the interior space of the temperature-controlled enclosure.

In some implementations, the inter-door insulating device includes a blade extending across at least a portion of a gap between the two doors.

In some implementation, a closure mechanism is coupled to the upper hinge or the lower hinge and configured to close the door.

In some implementations, the closure mechanism includes a hydraulic closure mechanism.

In some implementations, the system includes a hold-open device coupled between the door and the frame assembly.

In some implementations, the frame assembly includes an upper reinforcing member.

In some implementations, the door further includes an upper gasket coupled to the door assembly on the rear surface of the door assembly along an upper edge of the door, and a lower gasket coupled to the door assembly on the rear surface of the door assembly along a lower edge of the door. The upper gasket and the lower gasket are each configured to form a seal between the frame assembly and the door when the door is closed.

In some implementations, the door further includes a ridge projecting from the rear surface of the door between at least a portion of at least one of the gaskets and the interior space of the enclosure. The ridge extends across at least a portion of an air gap between the rear surface of the door and a front surface of the frame assembly.

In some implementations, the temperature-controlled enclosure further includes an adapter system configured to couple at least one of the doors to the frame assembly, wherein the adapter system includes an adapter plate.

In some implementations, the adapter system is configurable to adjust a position of at least a portion of the door.

In some implementations, the adapter system is configurable to adjust an inclination of the door.

In a general aspect of the disclosure, a door for a temperature-controlled enclosure includes an insulated panel assembly and an upper and lower hinge. The insulated panel assembly includes two or more panes each including an outer edge. The upper hinge and the lower hinge each include a hinge axis and is coupled to the insulated panel assembly such that the hinge axes are inside the outer edge of at least one of the two or more panes.

In some implementations, the door includes a guard configured to couple on the insulated panel assembly to protect at least one of the outer edges.

In some implementations, the door includes a hydraulic closure mechanism coupled to at least one of the upper hinge and the lower hinge.

In some implementations, the door includes a rail above or below at least a portion of at least one of the panes, wherein at least a portion of the hydraulic closure mechanism runs along the rail.

In a general aspect of the disclosure, a temperature-controller enclosure for displaying cold items includes a body, a frame assembly, and one or more doors coupled to the frame assembly. The body includes a front opening and defining an interior space of the enclosure. The frame assembly is coupled in the front opening of the body. The insulating device is coupled to the frame assembly and configured to be in contact with a surface of at least one of the doors when the door is closed on the temperature-controlled enclosure such that heat transfer is inhibited between ambient air around the temperature-controlled storage enclosure and the interior space of the temperature-controlled enclosure.

In some implementations, the insulating device is configured to fill at least a portion of a gap between a side edge of the door and the frame assembly.

In some implementations, the insulating device includes one or more blades configured to resiliently contact a portion of the door when the door assembly is closed.

In some implementations, at least one of the blades includes a flexible material.

In some implementations, the blades include a first blade and a second blade. The first blade and the second blade each lay on a surface of the door in opposite directions from one another.

In some implementations, the blades include a first blade and a second blade. The first blade is configured to bear against a rear surface of the door when the door is closed. The second blade is configured to bear against an outer edge surface of the door when the door is closed.

In some implementations, the one or more doors include two or more doors. At least one of the doors includes an inter-door insulating device extending between two of the doors and configured to inhibit heat transfer between ambient air around the temperature-controlled storage enclosure and the interior space of the temperature-controlled enclosure.

In some implementations, the door includes an insulated panel assembly including two or more panes each including an outer edge, and an upper hinge and a lower hinge each including a hinge axis and coupled to the insulated panel assembly such that the hinge axes are inside the outer edge of at least one of the two or more panes.

In some implementations, at least one of the first blade and the second blade are coupled to a contact plate of the frame assembly.

In a general aspect of the disclosure, an insulating device for a temperature-controlled enclosure includes a first blade and a second blade. The first blade is configured to couple to a frame assembly of a temperature-controlled enclosure and to be in contact with a door of the temperature-controlled enclosure at a first contact area when the door is closed on the temperature-controlled enclosure. The second blade is configured to couple to the frame assembly of the temperature-controlled enclosure.

In some implementations, the first blade and the second blade are configured to form a seal on at least a portion of a side edge of the door.

In some implementations, the first blade and the second blade inhibit heat transfer between ambient air around the temperature-controlled storage enclosure and the interior space of the temperature-controlled enclosure.

In some implementations, at least one of the blades is configured to couple to a contact plate of the frame assembly.

In some implementations, the first blade and the second blade include a flexible material.

In a general aspect of the disclosure, a method of insulating a temperature-controlled enclosure includes providing a seal on a top edge and a bottom edge between a door and a frame assembly of the temperature-controlled enclosure; and attaching an insulating device to a thermal frame member on at least one side of the door such that the insulating device fills a gap between the side of the door and the thermal frame member when the door is closed such that heat transfer is inhibited between ambient air around the temperature-controlled storage enclosure and the interior space of the temperature-controlled enclosure.

In some implementations, the insulating device resiliently engages a surface of the door.

In some implementations, a first blade of the insulating device bears against a rear surface of the door when the door is closed, and a second blade of the insulating device bears against an outer edge surface of the door.

In some implementations, the method further includes attaching an inter-door insulating device between the door and an adjacent door of the temperature-controlled enclosure.

In a general aspect of the disclosure, a temperature-controller enclosure for displaying cold items includes a body, a frame assembly, one or more doors coupled to the frame assembly, and an insulating device. The body includes a front opening and defining an interior space of the enclosure. The frame assembly is coupled in the front opening of the body. At least one of the doors includes an insulated panel assembly, an upper and lower hinge, and a hydraulic closure mechanism. The insulated panel assembly includes two or more panes each including an outer edge. The upper hinge and the lower hinge are coupled to the insulated panel assembly. The hydraulic closure mechanism is coupled to the insulated panel assembly. At least a portion of the hydraulic closure mechanism above or below at least one of the two or more panes. The insulating device is configured to seal at least a portion of a side edge of the door when the door is closed on the temperature-controlled enclosure.

In some implementations, the insulating device is attached to the frame assembly and configured to resiliently engage a portion of the door when the door is closed on the temperature-controlled enclosure.

In some implementations, the door includes a rail above or below at least a portion of at least one of the panes, and at least a portion of the hydraulic closure mechanism runs along the rail.

In some implementations, the upper hinge and the lower hinge each include a hinge axis. The upper hinge and lower hinge are coupled to the insulated panel assembly such that the hinge axes are inside the outer edge of at least one of the two or more panes.

The concepts described herein may provide several advantages. For example, some implementations may provide a more visible merchandising area of a display case. Implementations may provide a frame with improved visibility of the contents of the enclosure in the vertical sections of a door. Implementations may reduce the weight of a display door. Implementations may provide a frame with improved thermal efficiency. Implementations may prevent or minimize condensation build up on door sealing surfaces. Implementations may provide for a more positive thermal seal between a thermal frame and a door.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a front view of a refrigerated enclosure having multiple doors supported by a frame according to some implementations.

FIG. 2 is a perspective view door system for a refrigerated enclosure having four doors supported in a thermal frame according to some implementations.

FIG. 3 is a front view of the door and frame assembly at a lower hinge.

FIG. 4 is a bottom cross section view of the connection shown in FIG. 3.

FIG. 5 is a side cross section view of the connection shown in FIG. 3.

FIG. 6 is a detail view illustrating the relationship between the handle-sides of two adjoining doors at the top of the doors according to some implementations.

FIG. 7 is a detail view illustrating the upper hinges for the two middle doors of the door system shown in FIGS. 1 and 2.

FIG. 8 is a cross-sectional side view of a door system according to some implementations.

FIG. 9 is a cross sectional perspective view of a door including a closure mechanism according to some implementations.

FIG. 10 illustrates a hydraulic closure mechanism according to some implementations.

FIG. 11 is a perspective view illustrating a door having an insulated panel assembly with left and right side guards according to some implementations.

FIG. 12 is a detail view of the lower handle-side corner of the door shown in FIG. 11.

FIG. 13 is a detail view of the lower corner hinge-side corner of the door shown in FIG. 11.

FIG. 14 is a perspective view illustrating a thermal frame having an insulating device according to some implementations.

FIG. 15 illustrates an insulating device provided on a thermal frame engaged with a display door according to some implementations.

FIG. 16 illustrates one example of blades that lay on a door in the same direction as one another.

FIG. 17 is a horizontal cross-section review of a door system including side edge insulating devices.

FIG. 18 is a horizontal cross-sectional view of an inter-door insulating device at the junction between the outer hinge-side edges of two adjoining doors.

FIG. 19 is a horizontal cross-sectional view illustrating an inter-door insulating device according to some implementations.

FIG. 20 illustrates a display door connected to a thermal frame by way of an adapter according to some implementations.

FIG. 21 is an exploded view illustrating a door connection including an adapter that couples with a closure mechanism.

FIG. 22 illustrates an interface between an adapter plate and a thermal frame.

### DETAILED DESCRIPTION

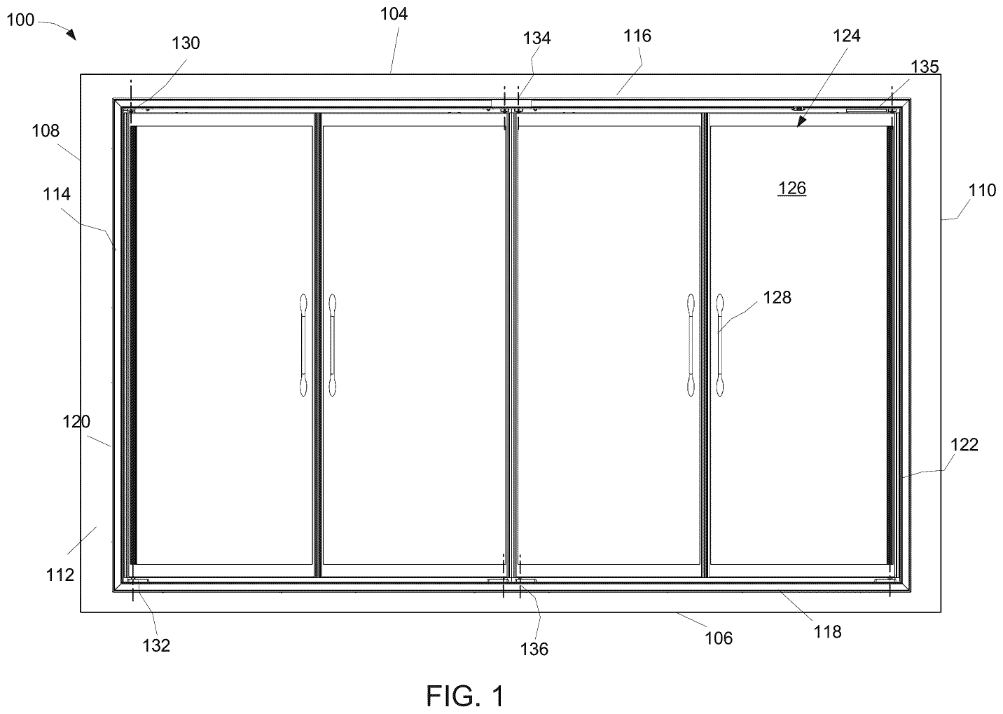

FIG. 1 show an exemplary refrigerated enclosure 100. Refrigerated enclosure 100 may be a refrigerator, freezer, or other enclosure defining a temperature-controlled space. In some implementations, refrigerated enclosure 100 is a refrigerated display case. For example, refrigerated enclosure 100 may be a refrigerated display case or refrigerated merchandiser in grocery stores, supermarkets, convenience stores, florist shops, and/or other commercial settings to store and display temperature-sensitive consumer goods (e.g., food products and the like). Refrigerated enclosure 100 can be used to display products that must be stored at relatively low temperatures and can include shelves, glass doors, and/or glass walls to permit viewing of the products supported by the shelves. In some implementations, refrigerated enclosure 100 is a refrigerated storage unit used, for example, in warehouses, restaurants, and lounges. Refrigerated enclosure 100 can be a free-standing unit or “built in” unit that forms a part of the building in which refrigerated enclosure 100 is located.

Refrigerated enclosure 100 includes a body 102. Body 102 includes a top wall 104, a bottom wall 106, a left side wall 108, a right side wall 110, a rear wall (not shown), and a front portion 112 defining a temperature-controlled space. Front portion 112 includes an opening into the temperature-controlled space. Thermal frame 114 can be mounted at least partially within the opening. Thermal frame 114 includes a plurality of perimeter frame segments (i.e., a header or top frame segment 116, a sill or bottom frame segment 118, a left-side frame segment 120, and a right-side frame segment 122 forming a closed shape along a perimeter of the opening.

Refrigerated enclosure 100 includes doors 124. Each of doors 124 includes an insulated panel assembly 126 and a handle 128. Each of doors 124 is connected to thermal frame 114 by way of an upper hinge 130 and a lower hinge 132. Insulated panel assembly 126 can include one or more panes of glass. In some implementations, insulated panel assembly 126 includes two or more layers of transparent panes bounding a sealed space in between, forming a sealed glass unit (SGU).

In some implementations, the gap or sealed space between two or more panels is filled with an insulating gas such as a noble gas (e.g., argon, krypton, etc.) which functions as a thermal insulator to reduce heat transfer through the panel. In some examples, the sealed space can be evacuated below atmospheric pressure.

Upper hinge 130 and the lower hinge 132 together define pivot axes 134, 136, respectively, about which display case door 124 swings. Pivot axis 134 and pivot axis 136 can be co-linear. Refrigerated enclosure 100 includes one or more hold-open devices 135 coupled between the doors and the thermal frame 114.

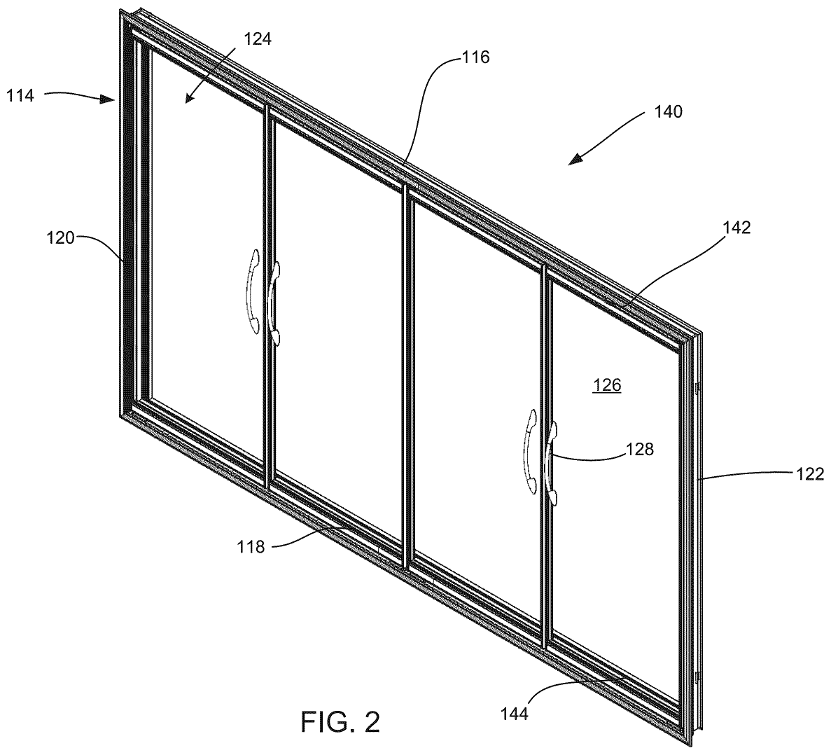

In certain implementations, a thermal frame (e.g., thermal frame 114) includes one or more mullion frame segments dividing the opening into multiple smaller openings. For example, enclosure 100 can include mullion frame segments extending between top frame segment 116 and bottom frame segment 118 to divide the opening into two smaller openings. Each of the smaller openings may correspond to a separate door (or in the example shown in FIG. 2., a separate pair of doors) of the assembly. In other implementations (for example, in the enclosure illustrated in FIG. 1), mullion frame segments are omitted.

FIG. 2 is perspective view of a door system that can be included in a temperature-controlled enclosure. Door system 140 includes thermal frame 114 and doors 124. Thermal frame 114 includes top frame segment 116, bottom frame segment 118, left-side frame segment 120, and right-side frame segment 122.

Each of doors 124 includes an insulated panel assembly 126, handle 128, an upper rail 142, and a lower rail 144. Each of insulated panel assemblies 126 is secured to a corresponding upper rail 142 and a corresponding lower rail 144. Each of doors 124 is connected to thermal frame by way of an upper hinge and a lower hinge (not shown in FIG. 2).

In FIGS. 1 and 2, refrigerated enclosure 100 is shown as a four-door assembly with two pairs of doors 124 positioned in an opening in front portion 112. Refrigerated enclosure 100 may have a lesser number of doors 124, or a greater number of doors 124. Applying a force to handle 128 causes the corresponding door 124 to rotate about hinges 130, 132 between an open position and a closed position. In some implementations, insulated panel assembly 126 is a transparent or translucent panel assembly through which items within a temperature-controlled space can be viewed when doors 124 are in the closed position. For example, insulated panel assembly 126 is shown to include a plurality of transparent or translucent panels with spaces there between. The spaces can be sealed and filled with an insulating gas (e.g., argon) or evacuated to produce a vacuum between the panels. In certain implementations, an insulated panel can include opaque panels with an insulating foam or other insulator there between.

For illustrative purposes, FIG. 2 shows a four-door assembly in which thermal frame 114 includes perimeter frame segments 116, 118, 120, and 122. In other implementations, thermal frame 114 includes a top frame segment and bottom frame segment with no side frame segments. In such implementations, thermal frame 114 can include one or more mullion frame segments depending, for example, on the size of the refrigerated enclosure in which thermal frame 114 is to be installed and the number of doors.

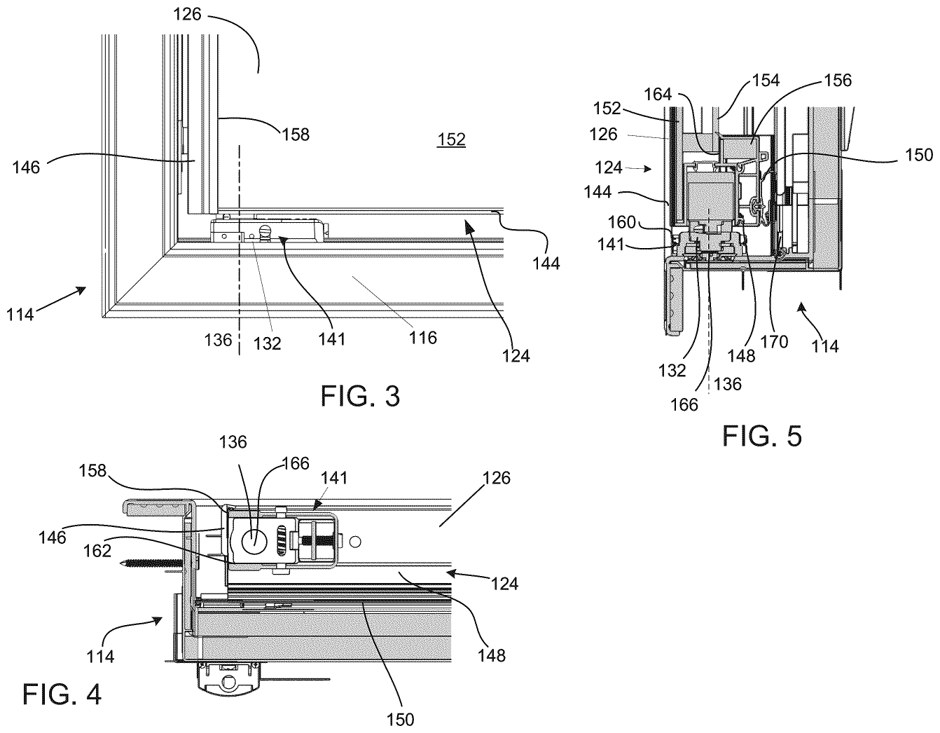

FIGS. 3, 4, and 5 illustrate a door hinge according to some implementations. FIG. 3 is a front view of the door and frame assembly at a lower hinge. FIG. 4 is a bottom cross section view of the connection shown in FIG. 3. FIG. 5 is a side cross section view of the connection shown in FIG. 3. Door 124 is coupled to thermal frame 114 by way of lower hinge mechanism 141. Door 124 includes insulated panel assembly 126, upper rail 142, lower rail 144 (shown in FIG. 2), side guard 146, back cover 148, and gasket 150. Back cover 148 is coupled to lower rail 144. Gasket 150 is coupled to back cover 148. In some implementations, the lower hinge mechanism is included on door 124. Gasket 150 can be made of a resilient material, such as synthetic rubber.

In some implementations, insulated panel assembly 126 is coupled to upper rail 142 at the junction between the front surface of lower rail 144 and the rear surface of front pane 152.

Insulated panel assembly 126 includes front pane 152, rear pane 154, and spacer 156. Front pane 152 includes outer edge 158 and upper edge 160. Rear pane 154 includes outer edge 162 and upper edge 164.

Side guard 146 can be installed on (e.g., snapped onto) the side edge of insulated panel assembly 126. The forward lip of side guard 146 covers only a small portion of the front surface of front pane 152 (along the far-left portion of front pane 152).

Lower hinge mechanism 141 includes hinge pin 166 and adjustment device 168. Lower hinge mechanism 141 allows door 124 to rotate on hinge pin 166 about pivot axis 136. Pivot axis 136 is inside of outer edge 158 of front pane 152. Pivot axis 130 is also inside of the interior edge of side guard 146. A user of the enclosure may thus be able to view the contents of the enclosure through the far-left edge of door 124. In some implementations, a side guard is omitted, and the outer edge of the front pane of the door is exposed.

When door 124 is closed, gasket 150 resiliently bears on contact plate 170 of top frame segment 116 of thermal frame 114. Contact between gasket 150 and contact plate 170 may provide a seal along the lower edge.

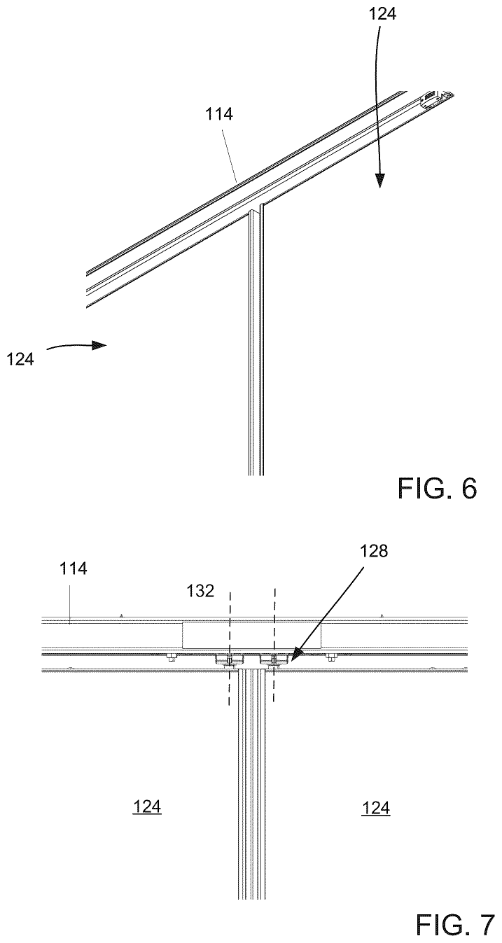

For clarity, only the lower hinge connection has been described with respect to FIGS. 1-5. The relationship of the upper hinge to the door can be similar to that of the lower hinge. FIG. 6 is a detail view illustrating the relationship between the handle-sides of two adjoining doors at the top of the doors. FIG. 7 is a detail view illustrating the upper hinges for the two middle doors of the door system shown in FIGS. 1 and 2.

In the implementations shown in FIGS. 1-7, refrigerated enclosure 100 includes one or more doors 124 pivotally mounted on the thermal frame 114 by hinges. In other implementations, doors 124 are sliding doors configured to open and close by sliding relative to the thermal frame 114. The pivot axis 136 for each of the lower hinges 132 can be inside of the outer edges of one or more panes of the insulated panel assembly 126 of the door. As used herein, “outer edge” of a pane of an insulated panel assembly refers to the edge away the handle side of the door (e.g., the side edge of the pane nearest to the hinge).

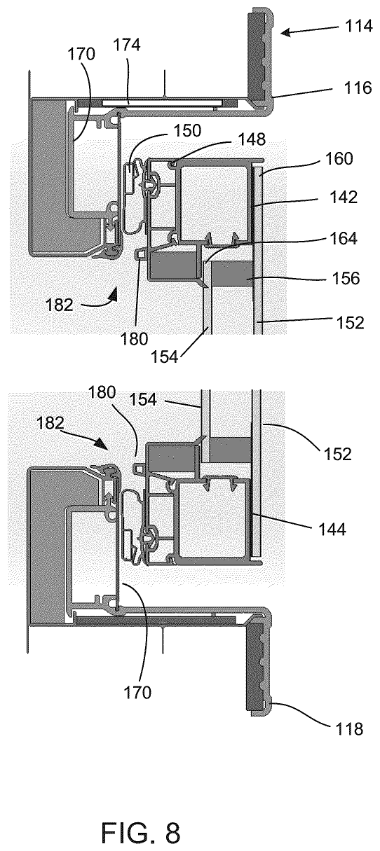

FIG. 8 is a cross-sectional side view of a door system according to some implementations. Door 124 is installed in thermal frame 114 (e.g., by a way of hinges as described above with respect to FIGS. 1-7). Door 124 includes insulated panel assembly 126, upper rail 142, lower rail 144, back covers 148, and gaskets 150. A back cover 148 is installed on (e.g., snapped onto) each of upper rail 142 and lower rail 144. A gasket 150 is installed on each of the back covers 148.

Thermal frame 114 includes a contact plate 170 on each top frame segment 116 and bottom frame segment 118. Contact plates 170 can be attached to a front surface of thermal frame 114 and provide a sealing surface against which doors 124 rest in the closed position. Gaskets 150 may employ a flexible bellows and magnet arrangement, which, when the doors 124 are closed, engage contact plates 170 to provide a seal between doors 124 and thermal frame 114. The thermal frames provide a thermally conductive path from the frame segments 116 and 118, for maintaining the temperature of the contact plates 170 at or close to the temperature of the external environment (e.g., the environment outside of the refrigerated enclosure 100) and to aid in preventing condensation from forming on the contact plates 170. Preventing condensation on the contact plates may provide for a more positive seal between the contact plates 170 and a magnetic gasket on the door, thereby improving the thermal properties of the refrigerated enclosure 100.

In some implementations, a labyrinthine air passage is at least partially defined by a projecting ridge that runs along the door gasket interior to (on the cold side of) the gasket for the door of a refrigerated enclosure. For example, in the door system shown in FIG. 8, back cover includes ridge 180. A ridge can be in the form of a rail, a bar, a plate, or other elongated element. The ridge can extend part way across an air gap between the inside face of the door and the front surface of the frame in which the door is installed. The ridge and the labyrinthine air passage may serve as a thermal barrier between the cold interior space of the enclosure and the warmer ambient outside of the enclosure.

Labyrinthine air passage 182 is defined by surfaces of ridge 180, each of frame segments 116 and 118, and gasket 150. Ridge 180 and labyrinthine air passage 182 may reduce velocity of air between gasket 150 and the interior space of temperature-controlled enclosure 100. A reduced air velocity near the gasket may improve thermal performance. Ridge 180 and labyrinthine air passage 182 may also reduce leakage at the mating surfaces between gasket 500 of door 124 and contact plate 170 of each of frame segments 116 and 118.

The projecting element for a labyrinthine feature can be made of various materials. In some implementations of a labyrinthine feature, the projecting element is flexible (such as Vinyl 78 shore A). In other implementations, the projecting element is rigid (such as rigid PVC). In some cases, a flexible material may allow for greater variations in the gap between the rear surface of the door and front surfaces of a frame.

In various implementations described and shown above, a ridge for a labyrinth feature extends across to a backing member of a frame assembly. A ridge can extend across toward other components, however, such as contact plate, a main frame member, or a retaining member.

Top frame segment 116 includes reinforcing member 174. Reinforcing member 174 can be a beam, rail, or bar, tube, or a combination of such elements. Reinforcing member 174 can provide support and rigidity to thermal frame 114 (e.g., under the weight of doors 124).

In some implementations, a door includes a closure mechanism. The closure mechanism can cause the door to close automatically when no external force (e.g., a user pulling on a door handle) is being exerted on the door. In some implementations, the closure mechanism is a hydraulic closure mechanism.

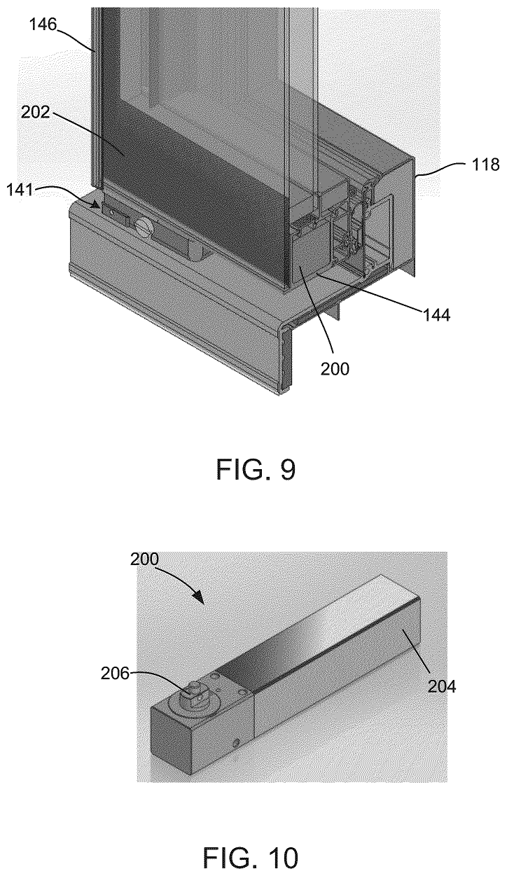

FIG. 9 is a cross sectional perspective view of a door including a closure mechanism according to some implementations. Door 124 is coupled to thermal frame 114 by way of lower hinge mechanism 141. Hydraulic closure mechanism 200 is coupled to hinge mechanism 141. Hydraulic closure mechanism 200 is housed in lower rail 144. Hydraulic closure mechanism 200 is located under at least one of the panes of insulated panel assembly 126.

FIG. 10 illustrates a hydraulic closure mechanism according to some implementations. Hydraulic closure mechanism 200 includes body 202 and closure pin 204.

In the implementation shown in FIG. 9, hydraulic closure mechanism 200 is installed in lower rail 144. In some implementations, a closure mechanism is mounted on a rear surface of a rail. In some implementations, a closure mechanism is located at an upper hinge of a door.

Referring again to FIG. 1, refrigerated enclosure 100 includes hold-open device 135. Hold-open device 135 can impart a hold-open force on the door to inhibit the door from swinging closed. The hold-open device 135 can, for example, keep the door from swinging closed under a closing force of hydraulic closure mechanism 200. The user can exert a force sufficient to overcome the holding force of the hold-open force, thereby allowing the door to close.

In some implementations, a door does not include a dedicated external structural member on one or more of the sides of the doors. For example, a door may omit a rail on the hinge side of the insulated panel assembly, a rail on the handle side of the insulated panel assembly, or both. Some doors described herein may provide increased visibility to the contents of a refrigerated enclosure.

In the example shown in FIGS. 1 through 10, the insulated panel assembly spans from the top rail of the door to the bottom rail of the door. The insulated panel assembly can carry all or substantially all of the structural loads imposed by the door on the hinges, thermal frame, and enclosure body (e.g., the user pulling on the handle of the door, the weight of the insulated panel assembly).

In some implementations, a door system includes side guards on one or more sides of the doors. Side guards can protect the edges of some or all of the panes of an insulated panel assembly (see, for example, FIGS. 3 through 5). In some implementations, side members also provide (alone or in combination with other elements of the system) thermal insulation and/or sealing between the interior space of the enclosure and the outside environment. Side insulating devices such as described below can be included, for example, on any of the door systems shown in FIGS. 1 through 10.

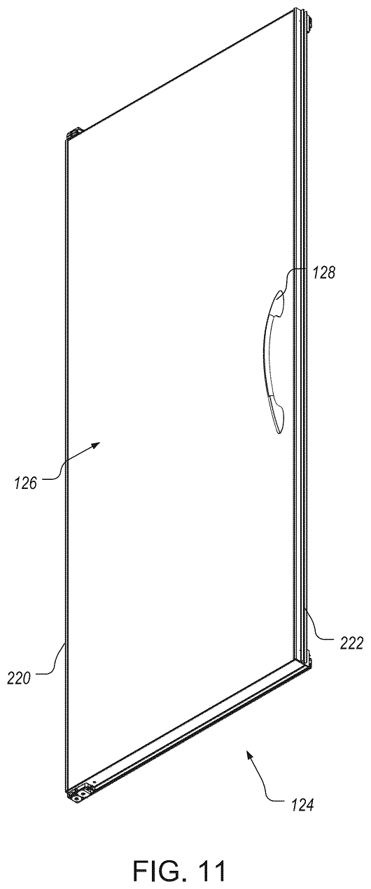

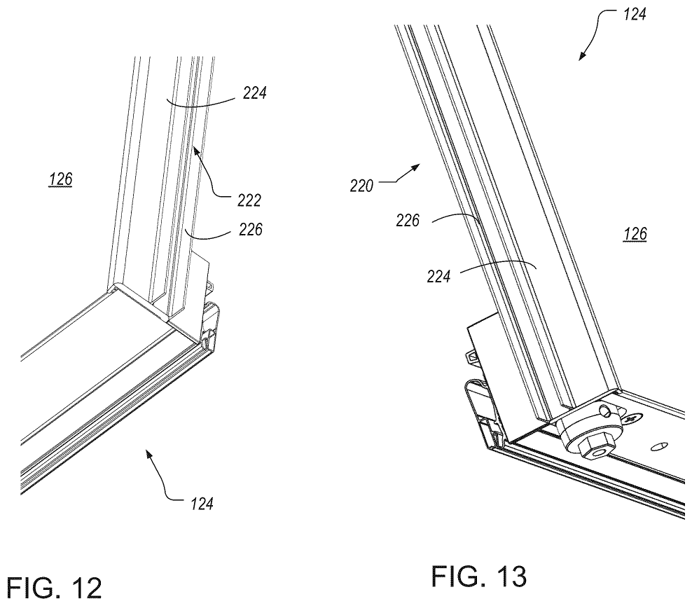

FIG. 11 is a perspective view illustrating a door having an insulated panel assembly with left and right side guards according to some implementations. FIG. 12 is a detail view of the lower handle-side corner of the door shown in FIG. 11. FIG. 13 is a detail view of the lower corner hinge-side corner of the door shown in FIG. 11. Door 124 includes insulated panel assembly 126, handle 128, hinge-side guard 220, and handle-side guard 222. Hinge-side guard 220 and handle-side guard 222 can run the height of the panes of insulated panel assembly 126.

Hinge-side guard 220 and handle-side guard 222 each include clip portion 224 and tabs 226. Clip portion can resiliently engage on the front and rear surfaces of the panes of the insulated panel assembly. Tabs 226 can be made of flexible material. Tabs 226 may at least partially fill a gap between the side of a door and an adjoining component.

In some implementations, one or both of tabs 226 are resilient (e.g., made of an elastomer). In some cases, tabs 226 can cooperate with an element on the other side of a junction (e.g., an adjacent door, or a thermal frame). In some implementations, a tab 226 on one door cooperates with a corresponding tab on the adjacent door to form to inhibit air flow between the doors.

In various implementations, a door system includes an insulating device between the side of a door and a thermal frame. Components of an insulating device between a door and thermal frame can be secured to the door, the thermal frame, or combination of both. In some implementations, the insulating devices include resilient elements, such as blades (e.g., wipers) that are of made a flexible material.

In various implementations, a door system includes an insulating device between the side of a door and the side of an adjoining door. Components of an insulating device between doors can be secured to one of the doors or combination of both doors. In some implementations, the insulating devices include resilient elements, such as blades (e.g., wipers) that are made of a flexible material.

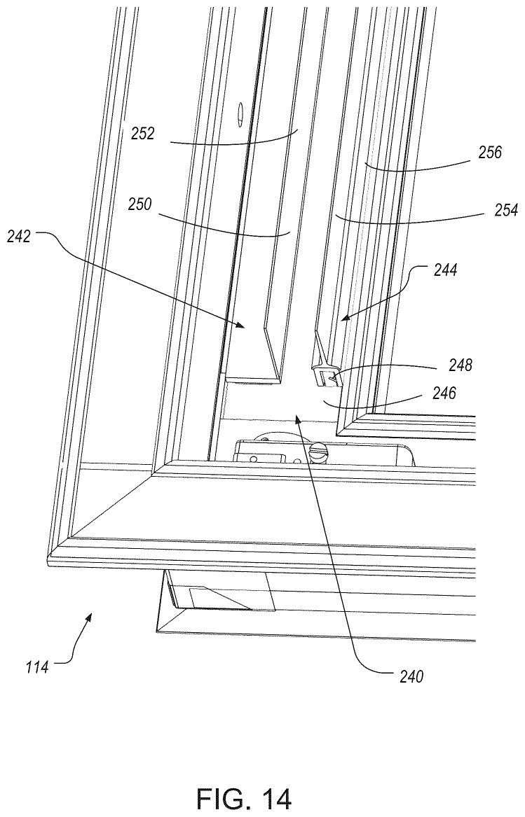

FIG. 14 is a perspective view illustrating a thermal frame having an insulating device according to some implementations. (For illustrative purpose, the insulating device is shown while the door is not installed in the frame). Thermal frame 114 includes insulating device 240. Insulating device 240 includes L-wiper 242 and push-on seal 244. L-wiper 242 and push-on seal 244 can be made of weather-resistant and water-resistant material.

L-wiper 242 and push-on seal 244 are attached to plate 246. Push-on seal 244 is installed on projecting rail 248, which projects from the front of plate 246. L-wiper 242 and push-on seal 244 can run the height of door 124, or only a portion of the height of door 124. L-wiper 242 includes blade 250 and base 252. Push-on seal 244 includes blade 254 and base 256. Base 256 includes groove 258. Base 256 can be attached to projecting rail 248 (for example, snapped onto projecting rail 248 at groove 258.

Blade 254 of push-on seal 244 and blade 250 of L-wiper 242 can be made of a flexible material, such as an elastomer. L-wiper 242 and push-on seal 244 are configured to bear against a portion of door 124. When door 124 (not shown in FIG. 14) is installed in thermal frame 114, the blades of L-wiper 242 and push-on seal 244 may each resilient bear against a portion of the installed door, thereby sealing the interior space of the temperature-controlled enclosure from air outside the enclosure. In some implementations, the interior space is sealed when the door is closed.

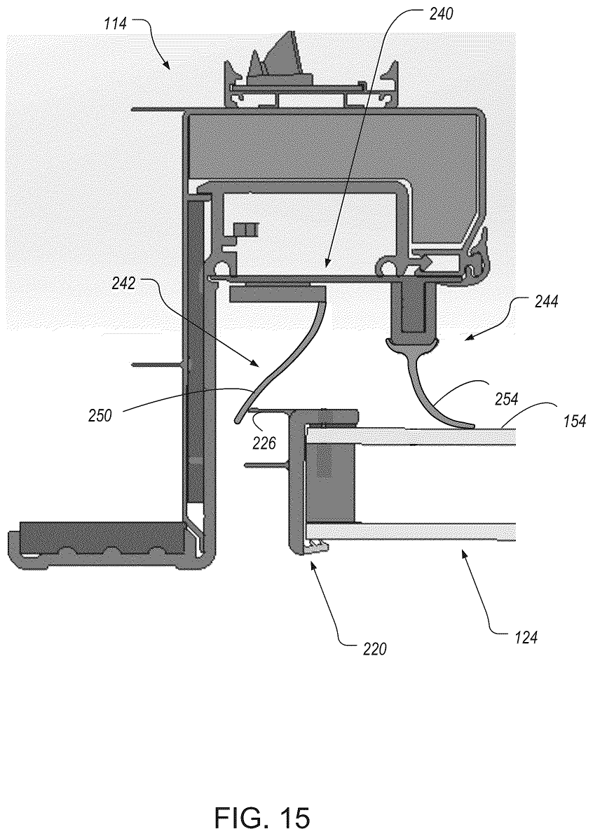

FIG. 15 illustrates an insulating device provided on a thermal frame engaged with a display case door according to some implementations. Insulating device 240 includes L-wiper 242 and push-on seal 244. L-wiper 242 and push-on seal 244 are each deflected by, and bear against, a portion of door 124. Blade 250 of L-wiper 242 bears against a surface of side guard 220. Blade 254 of push-on seal 244 bears against an of rear pane 154. When door 124 is installed in thermal frame 114, insulating device can inhibit flow between the interior space of the temperature-controlled enclosure from air outside the enclosure. In some implementations, the interior space is sealed when the door is closed. In some implementations, reduced air flow and/or heat transfer in the space between the thermal frame and the outer edge of the door can increase thermal efficiency of a door system.

In some implementations, the rear-most of tabs 226 of hinge-side guard 220 and blade 250 of L-wiper 242 may mutually deflect one another. Deflection of blade 250 of L-wiper 242 and/or tab 226 of hinge-side guard 220 may improve a seal of insulating device 240.

In the implementation shown in FIG. 15, insulating device 240 includes two blades (e.g., a double wiper). In other implementations, an insulating device includes three or more blades. In some implementations, an insulating device includes only one blade. An insulating device can include other types of insulating elements, such as bars or pads.

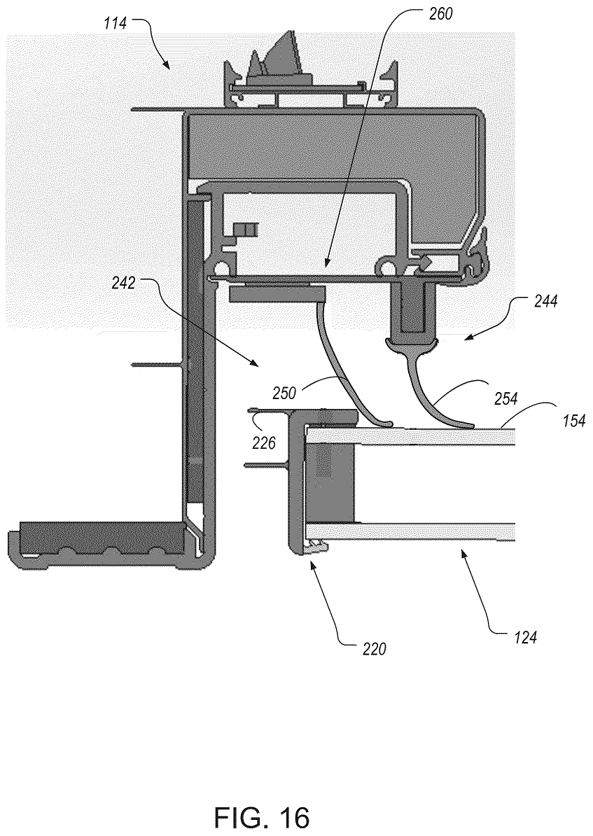

In the door system shown in FIG. 15, the blade 250 of L-wiper 242 and blade 254 of push-on seal 244 lay on door 124 in opposite directions from one another. In some implementations, two or more blades may lay against surfaces of a door in the same direction. FIG. 16 illustrates one example of blades that lay on a door in the same direction as one another. In this example, blade 250 of L-wiper 242 and blade 254 of push-on seal 244 lay in the same direction on a surface of rear pane 154 of door 124.

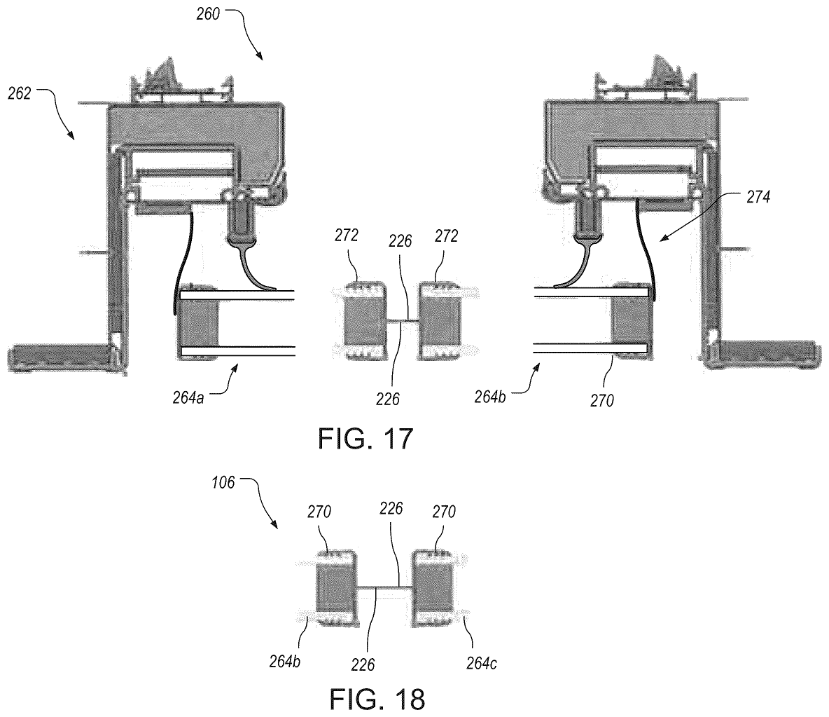

FIG. 17 is a horizontal cross-section review of a door system including side edge insulating devices in accordance with some implementations. Door system 260 includes thermal frame 262, door 264a, and door 264b. Thermal frame 262, door 264a, and door 264b and installed on a temperature-controlled enclosure. Doors 264a and 264b are installed on hinges.

Doors 264a and 264b includes hinge-side guards 270 and handle-side guards 272. Thermal frame 262 includes insulating devices 274. Handle-side guards 272 cooperate to provide an inter-door insulating device. For example, the handle-side guard 272 of door 264a can include a tab that mutually contacts and bears against a tab 226 on the handle-side guard 272 of door 264b.

FIG. 18 is a horizontal cross-sectional view of an inter-door insulating device at the junction between the outer hinge-side edges of two adjoining doors. An inter-door insulating device can be provided between hinged doors in a middle of a thermal frame, such as the middle two doors in the door system described above with respect to FIG. 1.

Doors 264a and 264b includes hinge-side guards 270. Hinge-side guards 270 cooperate to provide an inter-door insulating device. For example, the hinge-side guard 270 of door 264b can include a tab that mutually contacts and bears against a tab 226 on the handle-side guard 272 of door 264c.

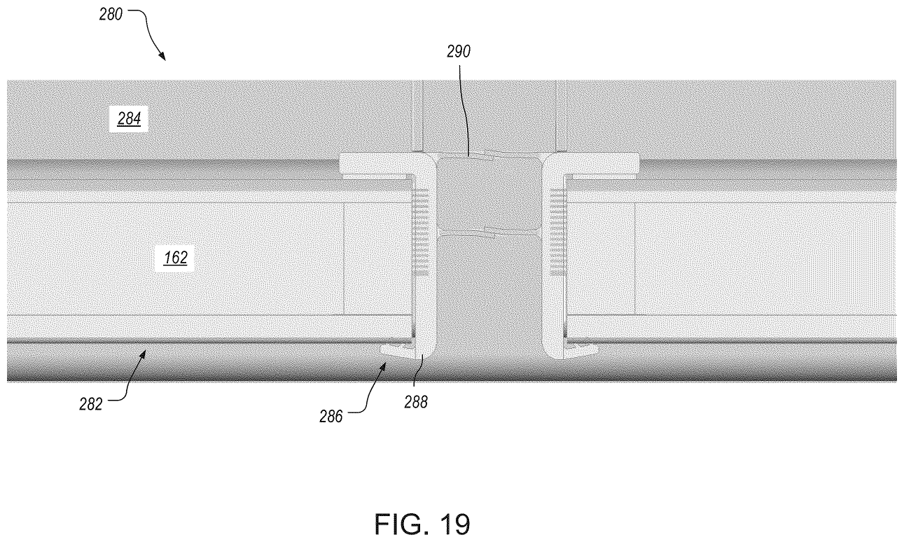

FIG. 19 is a horizontal cross-sectional view illustrating an inter-door insulating device according to some implementations. Door system 280 includes doors 282 in thermal frame 284. Each of doors includes insulated panel assembly 126 and side guards 286. Each of side guards 286 includes base 288 and a pair of tabs 290. Side guards 286 can extend the height of insulated panel assembly 126. Tabs 290 can be made of a flexible material, such as rubber.

Each of tabs 290 can mutually contact and bears against a tab on the adjoining door. Contact between tabs 290 may form a seal between the two doors and inhibit air flow and heat transfer between the interior space of the enclosure and the outside environment.

In the implementation shown in FIG. 19, each of the guards include two blades (e.g., a double wiper). In other implementations, an inter-door insulating device includes three or more tabs. In some implementations, an insulating device includes only one tabs. An insulating device can include other types of insulating elements, such as bars or pads.

In the implementation shown in FIGS. 3 and 9, the display door is connected to the thermal frame by way of an anchoring device with a bias-adjustment mechanism (e.g., a mechanism that can control torque on a torque rod in the door). In some implementations, a display door is connected to a thermal frame by way of an adapter plate.

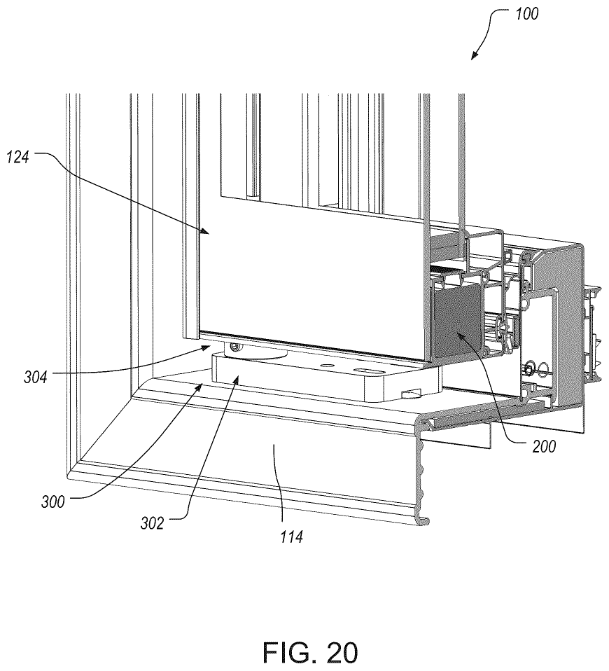

FIG. 20 illustrates a display door connected to a thermal frame by way of an adapter according to some implementations. Refrigerated enclosure 100 includes thermal frame 114 and door 124. Door 124 is coupled to thermal frame 114 by way of an adapter system 300. Adapter system 300 includes adapter plate 302 and connector 304. Adapter plate 302 is coupled to thermal frame 114. Hydraulic closure mechanism 200 of door 124 is coupled to adapter plate 302 by way of connector 304.

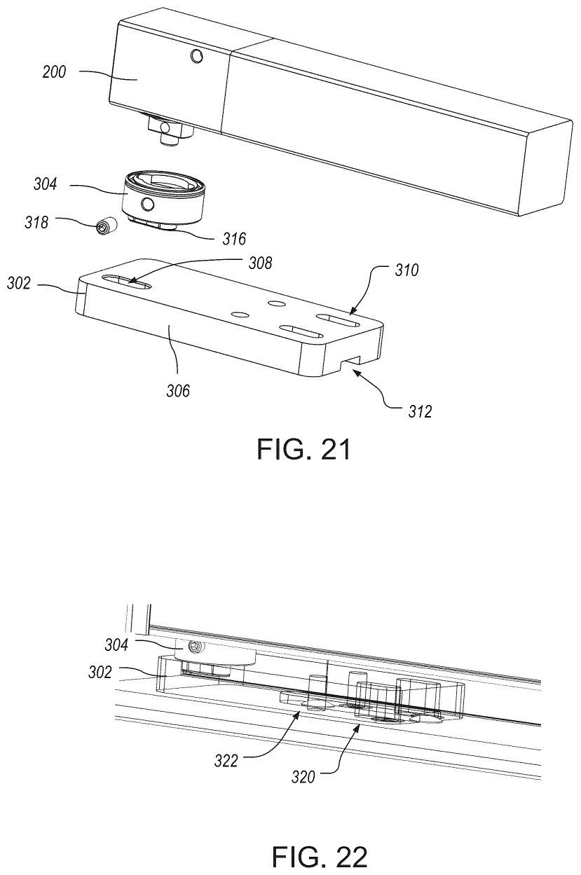

FIG. 21 is an exploded view illustrating a door connection including an adapter that couples with a closure mechanism. Adapter plate 302 includes body 306, receptacle 308, slots 310, and underside notch 312. Slots 310 and notch 312 can accommodate fasteners for coupling adapter plate 302 with thermal frame 114. Connector 304 includes projection 316. Connector 304 can be installed using set screw 318. Projection 316 can engage in receptacle 308.

FIG. 22 illustrates an interface between an adapter plate and a thermal frame. Adapter plate 302 includes apertures 320. Apertures 320 can accommodate fasteners 322. Fasteners 322 can be used to coupled adapter plate 302 to thermal frame 114. In some implementations, adapter plate 302, fasteners 322, connector 304, or combinations thereof, are adjusted to control a position and/or inclination of components of the adapter system, door 124, or both.

In various implementations described above, a temperature-controlled enclosure is illustrated a door of a display case. In some implementations, a display door for a temperature-controlled enclosure is a walk-in temperature-controlled enclosure.

In various implementations described above, upper and lower gaskets are provided on the door-side of the interface between a door and a thermal frame. A gasket can, however, in some implementations, be on the other side of the interface. For example, in some implementations, upper and lower gaskets are secured to a thermal frame that resiliently engages a contact plate on a rear surface of the door.

In various implementations described above, adjoining doors each include insulating elements that engage one another. In other implementations, an inter-door insulating device is provided only on one of the doors. For example, an inter-door insulating device can be attached to one door and resiliently engage an adjacent door.

As used herein, “coupled” includes directly or indirectly connected. Two elements are coupled if they contact one another (e.g., where faces of a frame member and a contact plate are in contact with one another.), but may also be coupled where they do not contact one another.

As used herein, the terms “perpendicular,” “substantially perpendicular,” or “approximately perpendicular” refer to an orientation of two elements (e.g., lines, axes, planes, surfaces, walls, or components) with respect to one and other that forms a ninety-degree (perpendicular) angle within acceptable engineering, machining, or measurement tolerances. For example, two surfaces can be considered orthogonal to each other if the angle between the surfaces is within an acceptable tolerance of ninety degrees (e.g., #1-5 degrees).

As used herein, a “ridge” includes any element or portion thereof that projects from a surface of a component over at least a portion of the surface. A ridge may be in the form of, for example, a rail, elongated protrusion, rim, bar, or lip. A ridge can project in any direction, including up, down, left, right, sideways, or obliquely.

As used herein, an “air passage” includes any space that allows air to move through or within. In some cases, an air passage can be a through passage that permits air to continuously flow through the passage from one end to another. In other cases, an air passage (or portion thereof) is a blind passage that does not allow for continuous airflow. Air movement in a passage can be caused by pressure differentials, thermal gradients, or otherwise. “Air passage” does not imply that air actually moves within the air passage.

As used herein, in the context of an air passage, a “labyrinthine” air passage includes two or more segments with at least one bend. An air passage having a labyrinthine shape may tend to inhibit flow of air through the passage.

It should be noted that the orientation of various elements may differ according to other exemplary embodiments, and that such variations are intended to be encompassed by the present disclosure.

While a number of examples have been described for illustration purposes, the foregoing description is not intended to limit the scope of the invention, which is defined by the scope of the appended claims. There are and will be other examples and modifications within the scope of the following claims. For example, the construction and arrangement of the refrigerated enclosure with thermal door frame as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the description and advantages of the subject matter disclosed herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present invention as defined in the appended claims. Other substitutions, modifications, changes, and omissions may be made in the design, operating conditions, and arrangement of the various exemplary embodiments without departing from the scope of the present inventions.

1. A temperature-controlled enclosure for displaying cold items, comprising:
a body comprising a front opening and defining an interior space of the enclosure;
a frame assembly coupled in the front opening of the body; and
one or more doors coupled to the frame assembly, at least one of the doors comprising:
an insulated panel assembly comprising two or more panes each comprising an outer edge; and
an upper hinge and a lower hinge each comprising a hinge axis and coupled to the insulated panel assembly such that the hinge axes are inside the outer edge of at least one of the two or more panes.

2. The temperature-controlled enclosure of claim 1, wherein the door further comprises an upper rail and a lower rail each coupled to the insulated panel assembly, the lower hinge is coupled to the lower rail, and the upper hinge is coupled to the upper rail.

3. The temperature-controlled enclosure of claim 1, wherein at least a portion of at least one of the upper hinge and the lower hinge is behind at least one of the panes.

4. The temperature-controlled enclosure of claim 1, wherein at least a portion of at least one of the upper hinge and the lower hinge is below at least one of the panes.

5. The temperature-controlled enclosure of claim 1, wherein further comprising an adhesive between at least one of the panes and at least one of the upper rail and the lower rail.

6. (canceled)

7. The temperature-controlled enclosure of claim 1, wherein further comprising an insulating device coupled to the frame assembly and configured to contact the door assembly such that heat transfer is inhibited between ambient air around the temperature-controlled storage enclosure and the interior space of the temperature-controlled enclosure.

8. (canceled)

9. (canceled)

10. The temperature-controlled enclosure of claim 1, wherein the one or more doors comprise two or more doors, at least one of the doors comprising an inter-door insulating device extending between two of the doors and configured to inhibit heat transfer between ambient air around the temperature-controlled storage enclosure and the interior space of the temperature-controlled enclosure.

11. The temperature-controlled enclosure of claim 1, wherein the inter-door insulating device comprises a blade extending across at least a portion of a gap between the two doors.

12. The temperature-controlled enclosure of claim 1, further comprising a closure mechanism coupled to at least one of the upper hinge or the lower hinge and configured to close the door.

13. (canceled)

14. (canceled)

15. The temperature-controlled enclosure of claim 1, wherein the frame assembly comprises an upper reinforcing member.

16. The temperature-controlled enclosure of claim 1, wherein the door further comprises:
an upper gasket coupled to the door assembly on the rear surface of the door assembly along an upper edge of the door, and
a lower gasket coupled to the door assembly on the rear surface of the door assembly along an lower edge of the door,
wherein the upper gasket and the lower gasket are each configured to form a seal between the frame assembly and the door when the door is closed.

17. (canceled)

18. The temperature-controlled enclosure of claim 1, further comprising an adapter system configured to couple at least one of the doors to the frame assembly, wherein the adapter system comprises an adapter plate.

19. (canceled)

20. (canceled)

21. A door for a temperature-controlled enclosure, comprising:
an insulated panel assembly comprising two or more panes each comprising an outer edge; and
an upper hinge and a lower hinge each comprising a hinge axis and coupled to the insulated panel assembly such that the hinge axes are inside the outer edge of at least one of the two or more panes.

22. The door of claim 21, further comprising a guard configured to couple on the insulated panel assembly to protect at least one of the outer edges.

23. The door of claim 21, further comprising a hydraulic closure mechanism coupled to at least one of the upper hinge and the lower hinge.

24. The door of claim 21, further comprising a rail above or below at least a portion of at least one of the panes, wherein at least a portion of the hydraulic closure mechanism runs along the rail.

25. A temperature-controlled enclosure for displaying cold items, comprising:
a body comprising a front opening and defining an interior space of the enclosure;
a frame assembly coupled in the front opening of the body;
one or more doors coupled to the frame assembly; and
an insulating device coupled to the frame assembly and configured to be in contact with a surface of at least one of the doors when the door is closed on the temperature-controlled enclosure such that heat transfer is inhibited between ambient air around the temperature-controlled storage enclosure and the interior space of the temperature-controlled enclosure.

26. The temperature-controlled enclosure of claim 25, wherein the insulating device is configured to fill at least a portion of a gap between a side edge of the door and the frame assembly.

27. The temperature-controlled enclosure of claim 25, wherein the insulating device comprises one or more blades configured to resiliently contact a portion of the door when the door assembly is closed.

28. (canceled)

29. (canceled)

30. (canceled)

31. (canceled)

32. The temperature-controlled enclosure of claim 25, wherein the door comprises:
an insulated panel assembly comprising two or more panes each comprising an outer edge; and
an upper hinge and a lower hinge each comprising a hinge axis and coupled to the insulated panel assembly such that the hinge axes are inside the outer edge of at least one of the two or more panes.

33.-46. (canceled)
